(19) United States
(12) Patent Application Publication
(10) Pub. No.: US 2013/0219954 A1
(43) Pub. Date: Aug. 29, 2013

(54) COOLING DEVICE AND METHOD FOR PRODUCING THE SAME

(71) Applicants: Masaka Chiba, Tokyo (JP); Minoru Yoshikawa, Tokyo (JP); Hitoshi Sakamoto, Tokyo (JP); Kenichi Inaba, Tokyo (JP); Arihiro Matsunaga, Tokyo (JP)

(72) Inventors: Masaka Chiba, Tokyo (JP); Minoru Yoshikawa, Tokyo (JP); Hitoshi Sakamoto, Tokyo (JP); Kenichi Inaba, Tokyo (JP); Arihiro Matsunaga, Tokyo (JP)

(73) Assignee: NEC CORPORATION

(21) Appl. No.: 13/882,711

(22) PCT Filed: Oct. 31, 2011
(86) PCT No.: PCT/JP2011/075531

§ 371 Date: Apr. 30, 2013

(30) Foreign Application Priority Data
Nov. 2, 2010 (JP) 2010-246187

(51) Int. Cl. F28D 15/02; B23P 15/26

(52) U.S. Cl. CPC F28D 15/02; B23P 15/26
USPC 62/513; 29/890.03

(57) ABSTRACT

In a cooling device using an ebullient cooling system, cooling performance adversely decreases if the evaporator includes projections activating convection heat transfer and the bubble nuclei are formed on the inner wall surface. A cooling device according to an exemplary embodiment includes an evaporator storing a refrigerant and a condenser condensing and liquefying a vapor-state refrigerant vaporized in the evaporator and radiating heat. The evaporator includes a base thermally contacting with an object to be cooled, and a container. The base includes a plurality of projections on a boiling surface of a surface at an inner wall side contacting with the refrigerant. The cross-sectional area cut along a plane parallel to the boiling surface at the top of the projection is smaller than that at the boiling surface. The evaporator includes a bubble nucleus forming surface only on a part of a refrigerant contacting surface.

### TECHNICAL FIELD

The present invention relates to cooling devices for semiconductor devices and electronic apparatuses and the like, in particular, to a cooling device and a method for producing the same using an ebullient cooling system in which heat transport and heat radiation are performed by a cycle of vaporization and condensation of a refrigerant.

### BACKGROUND ART

In recent years, with the progress of high performance and high functionality in semiconductor devices and electronic apparatuses, the amount of heat generation from them has also been increasing. On the other hand, the miniaturization of semiconductor devices and electronic apparatuses has been advancing due to the popularization of portable devices. Because of such background, a cooling device with high efficiency and a small size is required. The cooling device using an ebullient cooling system in which heat transport and heat radiation are performed by a cycle of vaporization and condensation of a refrigerant, is expected as a cooling device for semiconductor devices and electronic apparatuses because it does not require any driving unit such as a pump.

An example of the cooling device using the ebullient cooling system (hereinafter, also denoted as an ebullient cooling device) is described in patent literature 1. The ebullient cooling device described in patent literature 1 includes an evaporator which stores a liquid phase refrigerant, and a condenser which condenses and liquefies the refrigerant steam evaporated by the heat received from a body to be cooled in the evaporator and radiates the heat. The evaporator includes cuboids convex parts made of the same material member as a boiling surface on the boiling surface at the side of the inner wall in contact with the liquid phase refrigerant. And a blasting treatment is processed using an abrasive material for all over the surface of the top surface and lateral surface of the convex parts and the flat surface other than the convex parts.

As shown in FIG. 8, in an evaporator 310 composing the related ebullient cooling device described in patent literature 1, a boiling surface 313 and whole surface of convex parts 314 are roughened by processing the blasting treatment, and bubble nuclei 315 which become source nuclei of bubbles are formed all over the surface. It is said that, for that reason, the generation of bubbles becomes much more frequent on the surfaces of an inner wall 316, and an efficient boil arises successively. Further, in addition to obtaining an effect of enhancing heat transfer because the convex part 314 plays the role of a fin as a projection, it is possible to obtain an effect that the area to be processed by the blasting treatment increases and bubble nuclei increase due to including the convex parts (projections) 314. It is said that, with all these factors, according to the ebullient cooling device in patent literature 1, it is possible to obtain the ebullient cooling device with excellent cooling performance because of the improvement in the boiling heat-transfer coefficient.

Patent Literature 1: Japanese Patent Application Laid-Open Publication No. 2003-139476 (paragraphs [0023] to [0049])

### DISCLOSURE OF INVENTION

### Problem to be Solved by the Invention

As mentioned above, in the related ebullient cooling device, the bubble nuclei 315 are formed on the boiling surface 313 and all surface of the convex parts (projections) 314 in the evaporator 310. However, because the bubbles generated on the side surfaces of the convex parts (projections) 314 prevent the bubbles generated on the boiling surface 313 from moving, the cooling performance adversely decreases.

As mentioned above, the related ebullient cooling device has a problem that the cooling performance adversely decreases if the evaporator includes projections activating the convection heat transfer and the bubble nuclei are formed on the inner wall surface.

The object of the present invention is to provide a cooling device and a method for producing the same which solve the problem mentioned above that in a cooling device using an ebullient cooling system, the cooling performance adversely decreases if the evaporator includes projections activating the convection heat transfer and the bubble nuclei are formed on the inner wall surface.

### Means for Solving a Problem

A cooling device according to an exemplary aspect of the invention includes an evaporator storing a refrigerant; a condenser condensing and liquefying a vapor-state refrigerant vaporized in the evaporator and radiating heat; and a connection connecting the evaporator and the condenser, wherein the evaporator includes a base thermally contacting with an object to be cooled, and a container; the base includes a plurality of projections on a boiling surface of a surface at an inner wall side contacting with the refrigerant; the projection is configured in which the size of a cross-sectional area cut along a plane parallel to the boiling surface at the top of the projection is smaller than that at the boiling surface; and the evaporator includes a bubble nucleus forming surface only on a part of a refrigerant contacting surface composed of the boiling surface and the surface of the projections.

A method for producing a cooling device according to an exemplary aspect of the invention includes the steps of: forming a plurality of projections on a boiling surface of a surface at an inner wall side contacting with a refrigerant in a base included by an evaporator storing the refrigerant; forming the projection so that the size of a cross-sectional area of the projection, which is cut along a plane parallel to the boiling surface, at the top of the projection will be smaller than that at the boiling surface; forming a bubble nucleus forming surface only on a part of a refrigerant contacting surface composed of the boiling surface and the surface of the projections; forming the evaporator by joining the base to a container; and connecting the evaporator to a condenser condensing and liquefying a vapor-state refrigerant vaporized in the evaporator and radiating heat.

### Effect of the Invention

According to the cooling device of the present invention, it is possible to obtain a cooling device with an ebullient cooling system whose cooling performance is improved.

### BRIEF DESCRIPTION OF THE DRAWINGS

FIG. 1 is a cross-sectional view showing a configuration of a cooling device in accordance with the first exemplary embodiment of the present invention.

FIG. 2 is a cross-sectional view showing a configuration of a cooling device in accordance with the second exemplary embodiment of the present invention.

FIG. 3 is a plan view showing a configuration of a base of the cooling device in accordance with the second exemplary embodiment of the present invention.

FIG. 4 is a cross-sectional view to illustrate a method for producing the cooling device in accordance with the second exemplary embodiment of the present invention.

FIGS. 5A, 5B, and 5C are process drawings to illustrate the method for producing the cooling device in accordance with the second exemplary embodiment of the present invention.

FIG. 6 is a cross-sectional view to illustrate another method for producing the cooling device in accordance with the second exemplary embodiment of the present invention.

FIG. 7 is a side view showing a configuration of the projection formed by another method for producing the cooling device in accordance with the second exemplary embodiment of the present invention.

FIG. 8 is a cross-sectional view showing a configuration of the related ebullient cooling device.

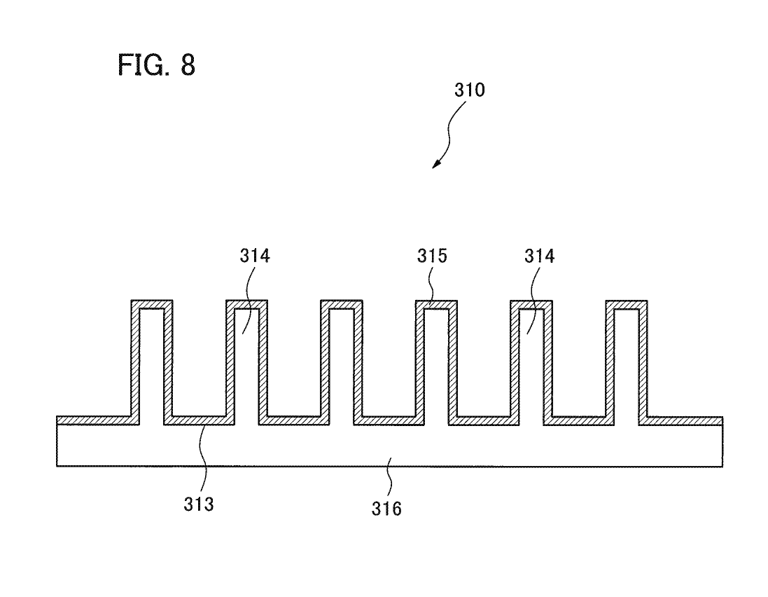

### DESCRIPTION OF EMBODIMENTS

The exemplary embodiments of the present invention will be described with reference to drawings below.

### The First Exemplary Embodiment

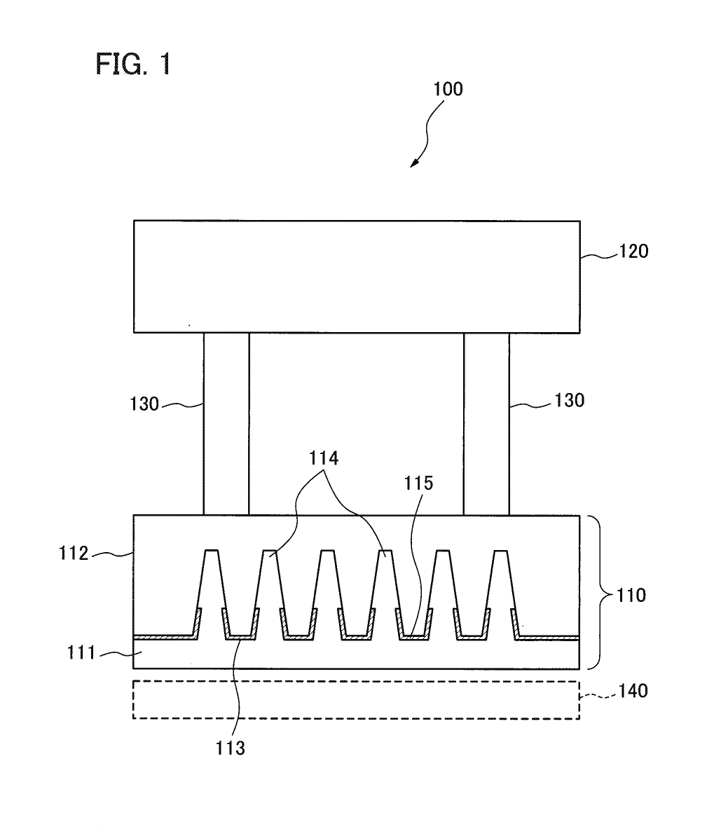

FIG. 1 is a cross-sectional view showing a configuration of a cooling device 100 in accordance with the first exemplary embodiment of the present invention. The cooling device 100 in accordance with the present exemplary embodiment includes an evaporator 110 storing a refrigerant, a condenser 120 condensing and liquefying a vapor-state refrigerant vaporized in the evaporator 110 and radiating heat, and a connection 130 connecting the evaporator 110 and the condenser 120.

The evaporator 110 includes a base 111 thermally contacting with an object to be cooled 140, and a container 112. The base 111 and the container 112 are joined by welding or brazing and the like to form a sealed structure, which stores the refrigerant inside it. The connection 130 is connected to the container 112, and the refrigerant circulates in a vapor-state or liquid-state between the evaporator 110 and the condenser 120 through the connection 130.

After enclosing the refrigerant in the evaporator 110, the evaporator 110 is evacuated. Thereby, the inside of the evaporator 110 is always maintained in the saturated vapor pressure of the refrigerant, and the boiling point of the refrigerant becomes equal to normal temperature. Therefore, when the object to be cooled 140 produces heat and the heat quantity is transferred to the refrigerant through the base 111, the refrigerant is vaporized and bubbles arise. At that time, since the heat quantity from the cooling to be object 140 is taken away as vaporization heat by the refrigerant, it is possible to avoid rise in temperature of the object to be cooled 140. The vaporized refrigerant flows through the connection 130, is cooled and condensed. in the condenser 120, and the refrigerant in liquid-state flows again into the evaporator 110 through the connection 130. It is possible for the cooling device 100 to cool the object to be cooled 140 by the foregoing circulation of the refrigerant without using a driving unit such as a pump.

The base 111 is provided with a plurality of projections 114 on a boiling surface 113 of a surface at an inner wall side contacting with the refrigerant. The projection 114 can be formed in the fin geometry, for example, and it has the effect to enhance the convection heat transfer when the bubbles of the refrigerant generated on the boiling surface 113 pass through. Accordingly, it is desirable to arrange these projections 114 in an interval in which the convection heat transfer by the bubbles becomes maximized. As the material of the base 111 and the projection 114, it is possible to use the metal having an excellent thermal conductive property such as aluminum, for example.

Moreover, the projection 114 in the present exemplary embodiment is configured in which the size of the cross-sectional area cut along the plane parallel to the boiling surface 113 at the top of the projection 114 is smaller than that at the boiling surface 113. That is to say, the interval between the plurality of projections 114 at the top of the projection 114 is larger than that on the boiling surface 113. FIG. 1 shows an example in which the projection 114 is trapezoidal in cross-section.

The evaporator 110 according to the present exemplary embodiment includes a bubble nucleus forming surface 115 only on a part of a refrigerant contacting surface composed of the boiling surface 113 and the surface of the projections 114. A plurality of bubble nuclei, each of which becomes a source nucleus for the bubbles of the refrigerant, are formed on the bubble nucleus forming surface 115, and each of the bubble nuclei has a concavo-convex shape with a projection and a hollow. The optimum value of the size of the concavo-convex shape is determined by considering physical properties such as surface tension of the refrigerant. For example, if hydrofluorocarbon, hydrofluoroether, and the like, which are insulating and inactive materials, are used as the refrigerant, the optimum size of the bubble nucleus is in the range of sub-micron to tens of micrometers in center line average roughness. Therefore, it is possible to form the bubble nuclei by a mechanical processing using abrasive grains, a sandblast, and the like, or by a chemical processing such as a plating. FIG. 1 illustrates a case that the bubble nucleus forming surface 115 is disposed only on the boiling surface 113 and the surface in the region of the projection 114 close to the boiling surface 113.

Thus, in the cooling device 100 according to the present exemplary embodiment, the projection 114 is configured in which the size of the cross-sectional area cut along the plane parallel to the boiling surface 113 at the top of the projection 114 is smaller than that at the boiling surface 113. By such configuration, since it becomes easy for the bubbles arising on the boiling surface 113 to desorb toward the upper part of the evaporator 110, the cooling performance of the cooling device 100 is improved.

The cooling device 100 according to the present exemplary embodiment includes the bubble nucleus forming surface 115 on the boiling surface 113 of the base 111 composing the evaporator 110. Therefore, the generation of the bubbles on the boiling surface 113 is activated and the cooling effect is enhanced.

In addition, in the evaporator 110 according to the present exemplary embodiment, the bubble nucleus forming surface 115 is disposed only on a part of the surface of the projection 114. Therefore, the bubbles generated on the surface of the projections 114 decrease. As a result, it is possible to suppress the phenomenon that the bubbles generated on the projection 114 prevent the bubbles generated on the boiling surface 113 from moving.

Here, the case is considered that the bubble nucleus forming surface is formed on entire surface of the projection 114 in order to increase the number of bubble nuclei, as the related ebullient cooling device described in the background art. Since the temperature of the projection 114 drastically decreases toward the upper part away from the boiling surface 113, the bubble nucleus forming surface disposed at the upper part of the projection 114 hardly contributes to generating the bubble. That is to say, the contribution to the cooling performance due to the increase in the number of the bubble nuclei is small. Accordingly, the decrease in the total number of the bubble nuclei has a small effect even though the bubble nucleus forming surface 115 is disposed on only a part of the surface of the projections 114.

As described above, according to the cooling device 100 of the present exemplary embodiment, it is possible to obtain a cooling device with an ebullient cooling system whose cooling performance is improved.

As mentioned above, the projection 114 hardly contributes to generating the bubbles, and the effect on the convection of the bubbles generated on the boiling surface 113 becomes dominant in the effects of cooling due to disposing the projection 114. Accordingly, it is possible to determine the interval of the projections 114 so that the convection heat transfer by the bubbles can be maximized taking into account the amount of generation and the rate of generation of the bubbles depending on the amount of heat generation of the object to be cooled 140. For example, if the amount of heat generation is in the range of about 100 W, it is possible to obtain excellent cooling performance on the condition that the interval of the projections 114 is in the range of about 0.1 mm to about 2 mm.

As mentioned above, once the bubbles arise at the projections 114, the flow of the bubbles arising on the boiling surface 113 is prevented. If the flow of the bubbles is prevented, the internal pressure of the evaporator 110 increases and the boiling temperature of the refrigerant which maintains the saturated vapor pressure also increases, therefore the cooling performance deteriorates. However, since the bubble nucleus forming surface 115 is disposed on only a part of the surface of the projection 114 in the evaporator 110 according to the present exemplary embodiment, the generation of the bubbles at the projection 114 is suppressed. Therefore, according to the present exemplary embodiment, it is possible to avoid the above-mentioned deterioration of the cooling performance.

### The Second Exemplary Embodiment

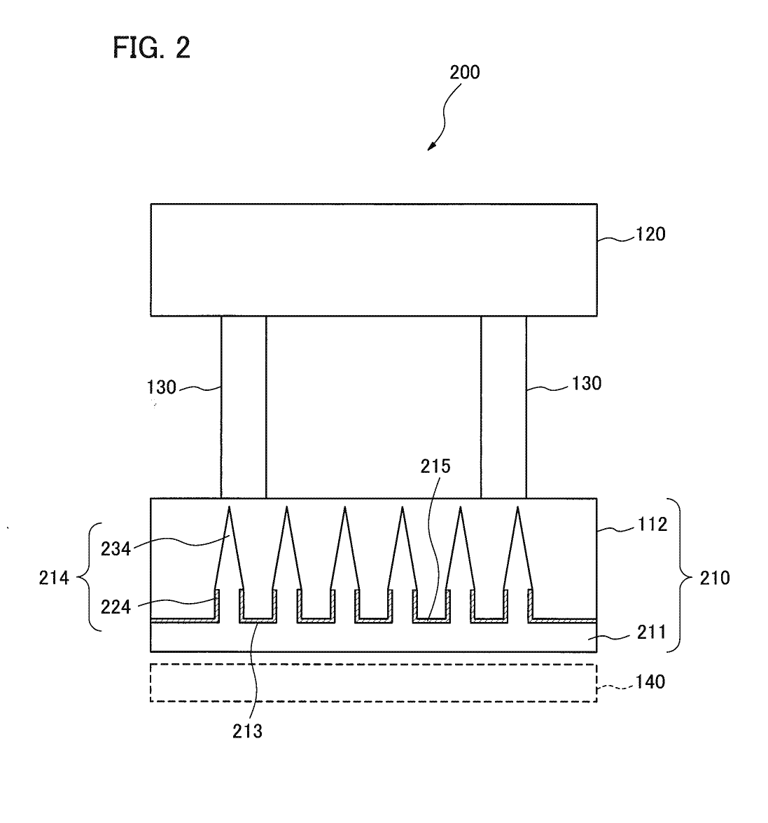

Next, the second exemplary embodiment according to the present invention will be described. FIG. 2 is a cross-sectional view showing the configuration of a cooling device 200 according to the second exemplary embodiment of the present invention. The cooling device 200 according to the present exemplary embodiment includes an evaporator 210 storing the refrigerant, the condenser 120 condensing and liquefying a vapor-state refrigerant vaporized in the evaporator 210 and radiating heat, and the connection 130 connecting the evaporator 210 and the condenser 120.

The cooling device 200 according to the present exemplary embodiment is different from the cooling device 100 of the first exemplary embodiment in the configuration of a projection 214 and a bubble nucleus forming surface 215 disposed in the evaporator 210. That is to say, in the evaporator 210 of the present exemplary embodiment, as shown in FIG. 2, the projection 214 includes a first projection component 224 disposed in contact with a boiling surface 213 and a second projection component 234 disposed on the first projection component 224. The projection 214 is composed of a rectangular plate with a rectangle-shaped board standing, for example, a fin-shaped plate. In the present exemplary embodiment, the cross-section shape of the projection 214, which is cut along the plane vertical to the longitudinal direction of the rectangular plate composing the projection 214, is rectangular in the first projection component 224, and triangular in the second projection component 234. And the evaporator 210 is configured to include the bubble nucleus forming surface 215 only on the boiling surface 213 and a lateral surface of the first projection component 224. The other configurations are the same as those in the first exemplary embodiment, therefore, the descriptions are omitted.

Thus, in the cooling device 200 according to the present exemplary embodiment, the cross-section of the first projection component 224 disposed in contact with the boiling surface 213 is a rectangular shape, and the cross-section of the second projection component 234 disposed thereon is a triangular shape. Therefore, the interval between the projections 214 at the upper part of the projection 214 (the second projection component 234) becomes larger than that on the boiling surface 213. By such configuration, since it becomes easy for the bubbles arising on the boiling surface 213 to desorb toward the upper part of the evaporator 210, the cooling performance of the cooling device 200 is improved.

The evaporator 210 according to the present exemplary embodiment includes the bubble nucleus forming surface 215 on the boiling surface 213 of the base 211. Therefore, the generation of the bubbles on the boiling surface 213 is activated and the cooling effect is enhanced.

Moreover, in the evaporator 210 in the exemplary embodiment, the bubble nucleus forming surface 215 is disposed only on the lateral surface of the first projection component 224 disposed in contact with the boiling surface 213. Therefore, the bubbles generated on the entire surface of the projections 214 decrease. As a result, it is possible to suppress the phenomenon that the bubbles generated on the projection 214 prevent the bubbles generated on the boiling surface 213 from moving. As described above, according to the cooling device 200 of the present exemplary embodiment, it is possible to obtain a cooling device with an ebullient cooling system whose cooling performance is improved.

Thus, in the cooling device 200 according to the present exemplary embodiment, the cross-section of the upper part of the projection 214 (the second projection component 234) is configured to be a triangular shape. And the bubble nucleus forming surface 215 is provided only on the boiling surface 213 and on the lateral surface of the first projection component 224 which is close to the boiling surface 213 and conducts the heat from the object to be cooled 140 easily. By adopting such configuration, it is possible to activate the generation of bubbles in the neighborhood of the boiling surface 213. Furthermore, it is possible to promote desorption of the generated bubbles toward the upper part of the evaporator 210 from the neighborhood of the boiling surface 213. As mentioned above, it is possible to improve the cooling performance of the cooling device 200.

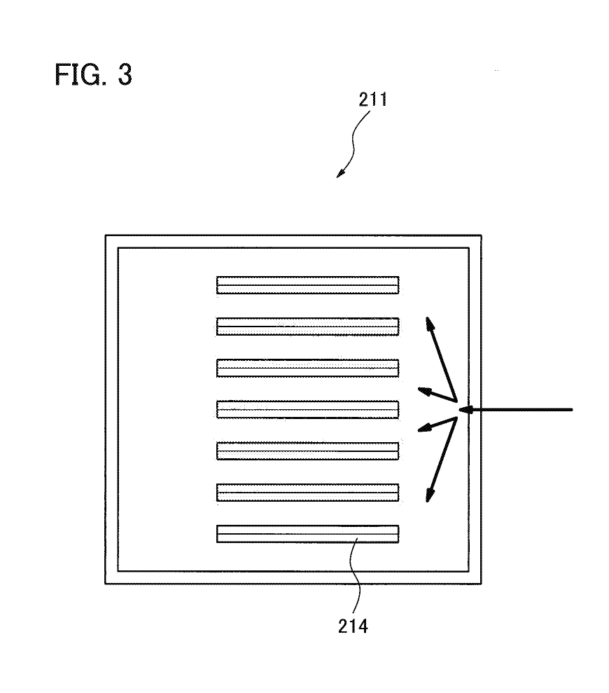

Next, the method for producing the cooling device 200 according to the present exemplary embodiment will be described. FIG. 3 is a plan view of the base 211 composing the evaporator 210 in the cooling device 200 according to the present exemplary embodiment. The base 211 includes the fin-shaped projections 214 which are located along the direction of the inflow of the refrigerant (in the direction of the arrows in the figure). By arranging the projections 214 along the direction in which the refrigerant flows, the influent refrigerant is able to take the heat away from the projections 214 using the effect of the convection heat transfer without its flow being disturbed. In order to enhance the effect, it is desirable that the projection 214 is configured as a plate-like fin (plate fin).

According to the method for producing the cooling device of the present exemplary embodiment, it is possible to form the projections 214 and the bubble nucleus forming surface in one process including a sequence of steps, as described below. First, the base 211 with the fin-shaped projections 219 is formed by means of the extrusion processing using die.

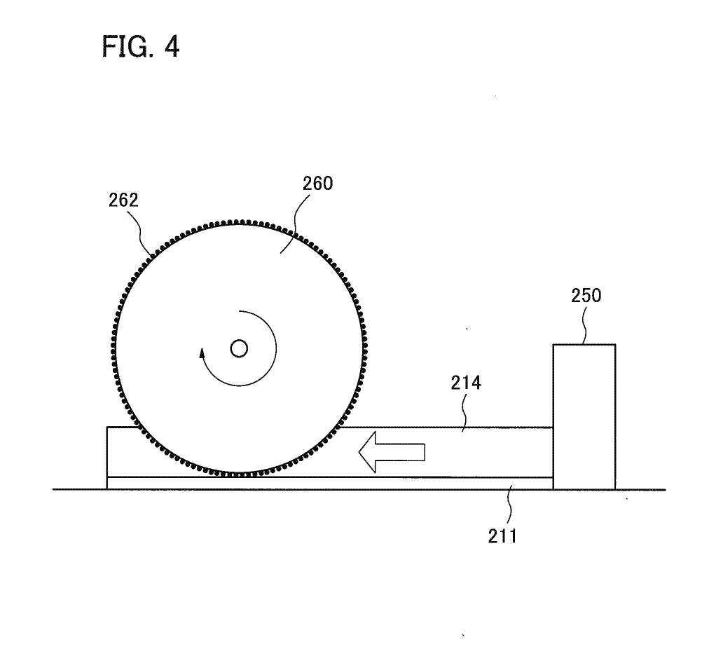

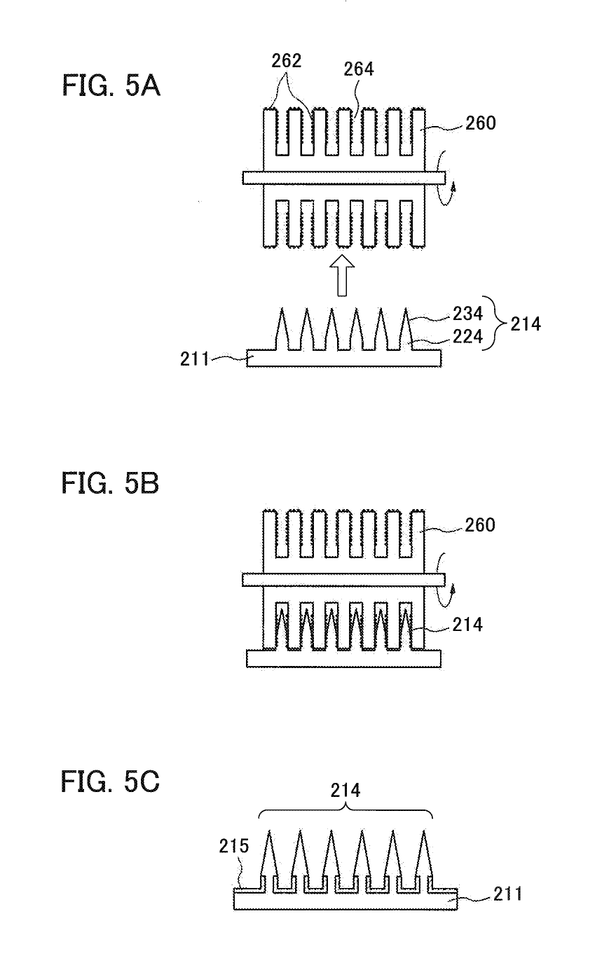

Then, as shown in FIG. 4, the bubble nucleus forming surface is formed by using a rotary forming unit 260 on the base 211 which is extruded from a die 250. The rotary forming unit 260 is cylindrically-shaped and abrasive grains 262 such as diamond micro particles (diamond slurry) and the like are formed on the side surface of the cylinder. As shown in FIG. 5A, the rotary forming unit 260 further includes on the side surface a groove 264 whose width and depth correspond to the width and height of the projection 214. The abrasive grains 262 are also formed on a part of the internal surface of the groove 264, that is, an area contacting with at least the side surface of the first projection component 224.

Next, the projection 214 of the evaporator is inserted into the groove 264 of the rotary forming unit 260, and they are arranged so that the abrasive grain 262 formed on the side surface of the rotary forming unit 260 can contact with the surface of the base 211 between the projections 214 (FIG. 5A). At that time, the abrasive grain 262 formed on the internal surface of the groove 264 of the rotary forming unit 260 contacts with the side surface of the first projection component 224. Then, as shown in FIG. 5B, by rotating the rotary forming unit 260, the concavo-convex shape corresponding to the shape of the abrasive grain 262 is formed only on the surface of the base 211 and the side surface of the first projection component 224. At that time, since the rotary forming unit 260 rotates, an arc-like concavo-convex shape is formed on the side surface of the first projection component 224.

It is possible to determine arbitrarily the size, shape, and distribution of the concavo-convex shape by specifying the size, shape and the like of the abrasive grain 262. Accordingly, by making the shape of the bubble nuclei determined by the refrigerant properties such as surface tension of the concavo-convex shape, it becomes possible to form the bubble nucleus forming surface 115 on the surface of the base 211, that is, only on the boiling surface and the side surface of the first projection component 224 (FIG. 5C). In particular, on the side surface of the first projection component 224, it is possible to form the bubble nucleus forming surface with bubble nuclei being disposed in a plurality of arcs-like shape. Even though the kind of refrigerant to be used differs, it is possible to form the bubble nucleus forming surface 115 including the bubble nuclei appropriate for the refrigerant to be used by changing the size, shape and the like of the abrasive grain 262 to fit the refrigerant properties.

After that, the base 211 and the container 112 are joined by welding or brazing and the like to form the evaporator 210. Finally the cooling device 200 according to the present exemplary embodiment is completed by connecting the evaporator 210 to the condenser 120 through the connection 130.

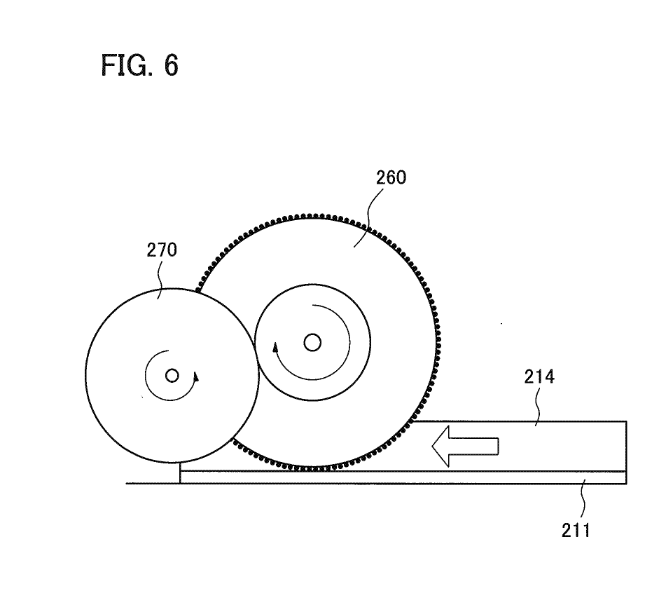

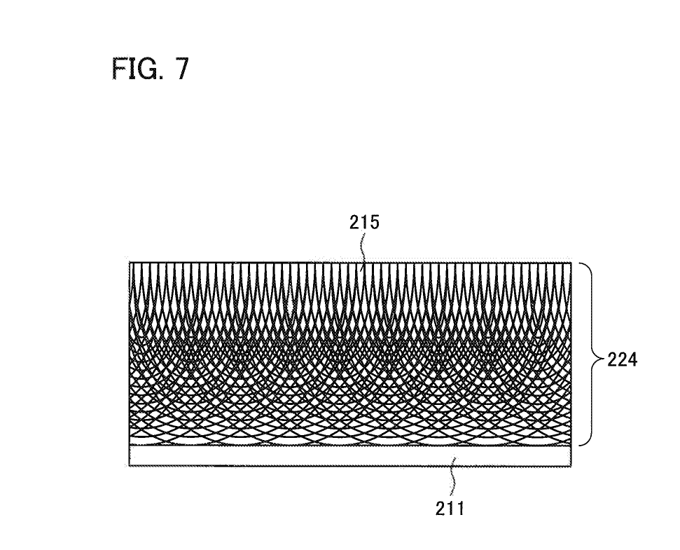

In the above-mentioned method for producing the cooling device, the bubble nucleus forming surface 115 is formed by using one rotary forming unit 260. However, not limited to this, as shown in FIG. 6, it is also acceptable to form the bubble nucleus forming surface 215 by adding a second rotary forming unit 270 with a different diameter and rotating it simultaneously with the rotary forming unit 260. In this case, as shown in FIG. 7, on the side surface of the first projection component 224, the bubble nucleus forming surface 215 is formed in which the bubble nuclei are disposed in the shape where lots of arcs are overlapped with shifting.

In the related ebullient cooling device described in the background art, the roughening process by the blasting treatment is performed all over the surface of the inner wall side in the evaporator. However, if the roughening process such as etching, plating, and sandblasting is performed with a masking process after forming the convex parts (projections), the production cost increases due to an increase in producing step.

In contrast, according to the method for producing the cooling device of the present exemplary embodiment, since it is possible to perform the roughening process, that is, to form the bubble nucleus forming surface 215 in one process continuous with the process for forming the projections, it is possible to suppress the increase in the production cost.

The present invention is not limited to the above-mentioned exemplary embodiments and can be variously modified within the scope of the invention described in the claims. It goes without saying that these modifications are also included in the scope of the present invention.

This application is based upon and claims the benefit of priority from Japanese patent application No. 2010-246187, filed on Nov. 2, 2010, the disclosure of which is incorporated herein in its entirety by reference.

### DESCRIPTION OF THE CODES

100, 200 cooling device

110, 210 evaporator

111, 211 base

112 container

113, 213 boiling surface

114, 214 projection

115, 215 bubble nucleus forming surface

120 condenser

130 connection

140 object to be cooled

224 first projection component

234 second projection component

250 die

260 rotary forming unit

262 abrasive grain

264 groove

270 second rotary forming unit

310 evaporator

313 boiling surface

314 convex portion

315 bubble nucleus

316 inner wall

1. A cooling device, comprising:
an evaporator storing a refrigerant;
a condenser condensing and liquefying a vapor-state refrigerant vaporized in the evaporator and radiating heat; and
a connection connecting the evaporator and the condenser;
wherein the evaporator comprises a base thermally contacting with an object to be cooled, and a container;
the base comprises a plurality of projections on a boiling surface of a surface at an inner wall side contacting with the refrigerant;
the projection is configured in which the size of a cross-sectional area cut along a plane parallel to the boiling surface at the top of the projection is smaller than that at the boiling surface; and
the evaporator comprises a bubble nucleus forming surface only on a part of a refrigerant contacting surface composed of the boiling surface and the surface of the projections.

2. The cooling device according to claim 1,
wherein the bubble nucleus forming surface is disposed only on the boiling surface and the surface in the region of the projection close to the boiling surface.

3. The cooling device according to claim 1,
wherein the bubble nucleus forming surface comprises a plurality of bubble nuclei, each of which becomes a source nucleus for the bubbles of the refrigerant; and
each of the bubble nuclei has a concavo-convex shape with a size determined by physical properties of the refrigerant.

4. The cooling device according to claim 3,
wherein the projection comprises a rectangular plate with a rectangle-shaped board standing, and comprises a first projection component and a second projection component;
the first projection component is disposed in contact with the boiling surface; and
a cross-section shape, which is cut along a plane vertical to the longitudinal direction of the rectangular plate, is rectangular in the first projection component, and triangular in the second projection component.

5. The cooling device according to claim 4,
wherein the evaporator comprises the bubble nucleus forming surface only on the boiling surface and a lateral surface of the first projection component.

6. The cooling device according to claim 5,
wherein the bubble nucleus forming surface disposed on the lateral surface of the first projection component comprises a configuration with the bubble nuclei being disposed in a plurality of arcs-like shape.

7. The cooling device according to claim 1,
wherein the plurality of projections are arranged in an interval in which the convection heat transfer by bubbles of the refrigerant becomes maximized.

8. A method for producing a cooling device, comprising the steps of:
forming a plurality of projections on a boiling surface of a surface at an inner wall side contacting with a refrigerant in a base comprised by an evaporator storing the refrigerant;
forming the projection so that the size of a cross-sectional area of the projection, which is cut along a plane parallel to the boiling surface, at the top of the projection will be smaller than that at the boiling surface;
forming a bubble nucleus forming surface only on a part of a refrigerant contacting surface composed of the boiling surface and the surface of the projections;
forming the evaporator by joining the base to a container; and
connecting the evaporator to a condenser condensing and liquefying a vapor-state refrigerant vaporized in the evaporator and radiating heat.

9. The method for producing the cooling device according to claim 8,
wherein the bubble nucleus forming surface is formed only on the boiling surface and the surface in the region of the projection close to the boiling surface.

10. The method for producing the cooling device according to claim 9, further comprising:
forming the projections by using an extruding method;
forming the bubble nucleus forming surface by using a rotary forming unit;
wherein the rotary forming unit comprises, on a side surface of a cylinder, a groove corresponding to the width and height of the projection, and abrasive grains are formed on the side surface and a part of an internal surface of the groove;
arranging the rotary forming unit so that the abrasive grain can contact with a surface of the base between the projections and a side surface of the projection;
forming the bubble nucleus forming surface with a concavo-convex shape corresponding to the shape of the abrasive grain on the surface of the base and the side surface of the projection by rotating the rotary forming unit; and
performing a step for forming the projections and a step for forming the bubble nucleus forming surface in a continuous process.
